(19) United States
(12) Patent Application Publication
(10) Pub. No.: US 2026/0191370 A1
(43) Pub. Date: Jul. 9, 2026

(54) KITCHEN TOWEL ROLL

(71) Applicant: Nippon Paper Crecia Co., Ltd., Chiyoda-ku, Tokyo (JP)

(72) Inventors: Misa SHIMIZU, Chiyoda-ku, Tokyo (JP); Yasunobu OOKA, Chiyoda-ku, Tokyo (JP); Riho IINO, Chiyoda-ku, Tokyo (JP); Hidehiko KAI, Chiyoda-ku, Tokyo (JP)

(73) Assignee: Nippon Paper Crecia Co., Ltd., Chiyoda-ku, Tokyo (JP)

(21) Appl. No.: 19/134,290

(22) PCT Filed: Nov. 29, 2023
(86) PCT No.: PCT/JP2023/042657

§ 371 Date: Jul. 17, 2025

(30) Foreign Application Priority Data
Nov. 30, 2022 (JP) 2022-191767

(51) Int. Cl. A47K 10/16; D21H 27/00

(52) U.S. Cl. CPC A47K 10/16; D21H 27/007

(57) ABSTRACT

A kitchen towel roll is provided that keeps basis weight within a prescribed range without excessively increasing it, and achieves a soft tactile feel and firmness while preserving strength and water absorption amount. The present disclosure relates to a kitchen towel roll obtained by bonding, with glue or water, sheets having an emboss pattern imparted to one or both of two plies, laminating the sheets to form a two-ply kitchen towel sheet, and winding the kitchen towel sheet into a roll, wherein: a basis weight of one ply of the kitchen towel sheet is 16 g/m² to 27 g/m²; a dry MD-direction tensile strength DMDT and a dry CD-direction tensile strength DCDT are 600 gf/25 mm to 1500 gf/25 mm, a ratio of the DCDT to the DMDT (DCDT/DMDT) is 0.3 to 2.5; bending resistances in both the MD and CD directions are 4.5 mN to 22.0 mN; and a water-absorption amount per unit area is 330 g/m² to 600 g/m².

### TECHNICAL FIELD

The present disclosure relates to a kitchen towel roll.

### BACKGROUND

In recent years, various types of kitchen towels have been developed.

For kitchen towels, strength and firmness during use are important, and papermaking technologies have been developed for ordinary base paper to increase the strength of the base paper in order to provide firmness.

Base paper obtained by the so-called TAD (Through Air Drying) papermaking technology using through-air drying is excellent as base paper for kitchen towel rolls, because it has high water absorbency and a soft texture.

As prior art documents for kitchen towel rolls, for example, PTL 1 discloses a kitchen towel roll 1 in which a kitchen towel sheet 1x, formed by laminating two plies of sheets having an emboss pattern imparted thereto and bonded with glue, is wound into a roll, wherein the kitchen towel sheet has an uneven pattern originating from the papermaking process that is different from the emboss pattern, the basis weight of the two plies is 30 g/m² or more and 54 g/m² or less, the paper thickness is 1.3 mm/10 sheets or more and 5 mm/10 sheets or less, the water absorption per 1 m² of the two plies is 220 g or more and 600 g or less, the wound length of the kitchen towel roll 1 is 14 m or more and 44 m or less, and the wound diameter is 110 mm or more and 189 mm or less.

### CITATION LIST

### Patent Literatures

PTL 1: JP 2022-116768 A

### SUMMARY

### Technical Problem

Kitchen towel rolls are required not only to have water absorbency and a soft texture, but also to have firmness (stiffness and rigidity of the paper) and to be resistant to tearing when wiping an object. However, in the case of TAD, since an uneven textured fabric is used to increase the paper thickness, the texture becomes softer rather than firmer, and the number of fibers that bond with each other by interfiber bonding is less than in conventional dry crepe papermaking machines, resulting in lower strength.

Therefore, when a conventional emboss (for example, a conventional emboss pattern such as a square, circular, or elliptical pattern) is used, the strength becomes low (cannot be maintained). To address this problem, the strength and water absorption can be maintained at a high level by increasing the basis weight, but this leads to increased costs.

The present disclosure has been made in view of such circumstances, and an object thereof is to provide a kitchen towel roll that keeps the basis weight within a certain range without excessively increasing it, and achieves a soft tactile feel and firmness while preserving strength and water absorption amount.

### Solution to Problem

The inventors conducted intensive studies and, in a kitchen towel roll obtained by bonding, with glue or water, sheets having an emboss pattern imparted to one or both of two plies, laminating the sheets to form a two-ply kitchen towel sheet, and winding the kitchen towel sheet into a roll, by setting the basis weight of one ply of the kitchen towel sheet, the dry MD and CD tensile strengths and their ratio, the MD-direction and CD-direction bending resistances, and the water absorption amount per unit area of the kitchen towel sheet each within a prescribed numerical range, it is possible to keep the basis weight within a certain range without excessively increasing it, and, while maintaining strength and water absorption, to achieve both a soft tactile feel and firmness, thereby completing the present disclosure. That is, the present disclosure provides the following.
(1) A first aspect of the present disclosure is a kitchen towel roll obtained by bonding, with glue or water, sheets having an emboss pattern imparted to one or both of two plies, laminating the sheets to form a two-ply kitchen towel sheet, and winding the kitchen towel sheet into a roll, wherein a basis weight of one ply of the kitchen towel sheets is 16 g/m² or more and 27 g/m² or less, a dry machine direction tensile strength DMDT and a dry cross direction tensile strength DCDT of the kitchen towel sheet according to JIS P 8113 are each 600 gf/25 mm or more and 1500 gf/25 mm or less, and a ratio of the DMDT to the DCDT (DMDT/DCDT) is 0.3 or more and 2.5 or less, a bending resistance of the kitchen towel sheet in the MD direction and in the CD direction is each 4.5 mN or more and 22.0 mN or less, and a water absorption amount per unit area of the kitchen towel sheet is 330 g/m² or more and 600 g/m² or less.
(2) A second aspect of the present disclosure is the kitchen towel roll according to (1), wherein a specific volume of the kitchen towel sheet is 7.6 cm³/g or more and 19.2 cm³/g or less.
(3) A third aspect of the present disclosure is the kitchen towel roll according to (1), wherein the emboss pattern is linear, and an area occupied byembossed parts having a width of 0.1 mm or more and 4 mm or less and a length of 5 mm or more in the linear emboss pattern accounts for 4% or more and 50% or less of an area of the kitchen towel sheet.
(4) A fourth aspect of the present disclosure is the kitchen towel roll according to (1), wherein an emboss depth in the emboss pattern is 0.06 mm or more and 1.05 mm or less.
(5) A fifth aspect of the present disclosure is the kitchen towel roll according to (1), wherein the kitchen towel sheet has an uneven pattern originating from a papermaking process that is different from the emboss pattern.
(6) A sixth aspect of the present disclosure is the kitchen towel roll according to (1), wherein a paper thickness of the kitchen towel sheets is 1.3 mm/10 plies or more and 5.0 mm/10 plies or less.
(7) A seventh aspect of the present disclosure is the kitchen towel roll according to (1), wherein a wound diameter of the roll is 110 mm or more and 189 mm or less.
(8) An eighth aspect of the present disclosure is the kitchen towel roll according to (1), wherein an MD-direction elongation of the kitchen towel sheet according to JIS P 8113 is 6% or more and 15% or less.
(9) A ninth aspect of the present disclosure is the kitchen towel roll according to (1), wherein a CD-direction elongation of the kitchen towel sheet according to JIS P 8113 is 3% or more and 10% or less.
(10) A tenth aspect of the present disclosure is the kitchen towel roll according to (1), wherein a softness of the wound roll is 1.2 mm or more and 4.0 mm or less.
(11) An eleventh aspect of the present disclosure is the kitchen towel roll according to (1), wherein a peel strength of the kitchen towel sheet is 0.03 N/100 mm or more and 0.5 N/100 mm or less.
(12) A twelfth aspect of the present disclosure is the kitchen towel roll according to (1), wherein a root mean square height of surface roughness, in a portion of the kitchen towel sheet where the emboss pattern is not imparted, is 35 μm or more and 170 μm or less.
(13) A thirteenth aspect of the present disclosure is the kitchen towel roll according to (1), wherein the kitchen towel sheet is wound on a paper core, and a weight content of LBKP (Bleached hardwood kraft pulp) in base paper used for the paper core is 50% or more and 100% or less.

### Advantageous Effect

According to the present disclosure, it is possible to provide a kitchen towel roll that keeps the basis weight within a certain range without excessively increasing it, and achieves a soft tactile feel and firmness while preserving strength and water absorption amount.

### BRIEF DESCRIPTION OF THE DRAWINGS

In the accompanying drawings:

FIG. 1 is a perspective view illustrating a kitchen towel roll according to one embodiment of the present disclosure.

FIG. 2 is a diagram illustrating a method for measuring the water absorption amount of the kitchen towel sheet of the present disclosure.

FIG. 3 is a diagram illustrating an example of an emboss pattern in the kitchen towel roll of the present disclosure.

FIG. 4 is a diagram indicating, in gradation, a height profile on the X-Y plane by a microscope.

FIG. 5 is a diagram presenting, as a graph, a height profile on the X-Y plane by a microscope.

FIG. 6 is a diagram illustrating a method for determining the emboss depth in the emboss pattern.

FIG. 7 is a diagram illustrating a part of the papermaking process of the kitchen towel sheet of the present disclosure.

FIG. 8 is a diagram indicating, in gradation, a height profile on the X-Y plane of a non-embossed portion by a microscope.

FIG. 9 is a perspective view of a kitchen towel roll package in which three kitchen towel rolls as illustrated in FIG. 1 are arranged side by side and film-wrapped.

### DETAILED DESCRIPTION

Hereinafter, embodiments for carrying out the present disclosure (hereinafter, simply referred to as “the present embodiment”) will be described in detail. The following embodiment is provided as an example to explain the present disclosure and is not intended to limit the present disclosure to the following content. The present disclosure can be appropriately modified and implemented within the scope of its gist.

In addition, in a kitchen towel sheet, the MD direction refers to the machine direction, which is the direction of flow during papermaking of the kitchen towel sheet, and the CD direction refers to the cross direction, which is perpendicular to the MD direction.

### (Kitchen Towel Roll)

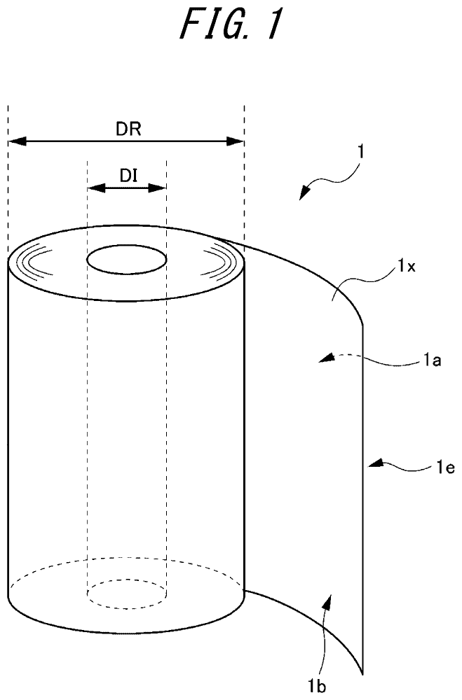

FIG. 1 is a perspective view illustrating a kitchen towel roll 1 according to one embodiment of the present disclosure. As illustrated in FIG. 1, the kitchen towel roll 1 according to the present embodiment is a kitchen towel roll 1 in which a kitchen towel sheet 1x, obtained by bonding with glue or water a sheet having an emboss pattern imparted to one or both of two plies and laminating the two plies, is wound into a roll. It is preferable that the kitchen towel sheet 1x is provided with perforations in the roll width direction at approximately regular intervals in the roll winding direction (not illustrated).

As illustrated in FIG. 1, among the surfaces of the kitchen towel sheet 1x, the surface facing outward from the roll is referred to as the front surface 1a (surface of the kitchen towel sheet 1x), and the surface facing the center of the roll is referred to as the back surface 1b (back surface of the kitchen towel sheet 1x). Further, the end of the kitchen towel sheet 1x is referred to as the outermost peripheral edge 1e of the kitchen towel roll 1.

Examples of uses for the kitchen towel roll 1 include, for example, kitchen paper (also referred to as paper towel, cooking paper, etc.) rolls (kitchen paper rolls) used for wiping water or oil components or removing dirt in household kitchens or restaurant kitchens, and other sanitary paper rolls, etc.

### (Wound Length and Wound Diameter)

The lower limit of the wound length of the kitchen towel roll 1 is preferably 14 m or more, more preferably 21 m or more, and even more preferably 25 m or more. The upper limit is preferably 44 m or less, more preferably 37 m or less, and even more preferably 33 m or less. By setting the wound length within the above numerical range, the wound diameter DR described later can be set within an appropriate range.

The wound length is measured as follows. First, for the kitchen towel sheet 1x between perforations of the kitchen towel roll 1, the length of 10 sheets is actually measured. Then, the number of sheets in the kitchen towel roll 1 is actually counted, and the wound length is calculated proportionally from the length of 10 sheets and the number of sheets. For example, if the length of 10 sheets is 1.80 m and the number of sheets is 150, then 1.80 m×(150/10)=27 m. If the kitchen towel roll 1 does not have perforations, the wound length is measured directly.

The wound diameter DR of the kitchen towel roll 1 according to the present embodiment is preferably 110 mm or more and 189 mm or less. By setting the wound diameter DR within the above numerical range, it is possible to provide a kitchen towel roll 1 that has a soft tactile feel and also has firmness.

The lower limit of the wound diameter DR is more preferably 130 mm or more, and even more preferably 140 mm or more. The upper limit is more preferably 176 mm or less, and even more preferably 163 mm or less.

The wound diameter DR of the roll is measured using “a diameter rule” manufactured by Muratec KDS Co., Ltd. Three kitchen towel rolls 1 are measured, and the average of the measurement results is used.

### (Roll Width and Roll Weight)

The lower limit of the roll width of the kitchen towel roll 1 is preferably 150 mm or more, more preferably 200 mm or more, and even more preferably 250 mm or more. The upper limit is preferably 380 mm or less, more preferably 340 mm or less, and even more preferably 300 mm or less. By setting the roll width within the above numerical range, it is possible to provide a kitchen towel roll 1 in which the basis weight, strength, and water absorption amount are maintained within certain ranges.

In addition, the lower limit of the roll weight of the kitchen towel roll 1 is preferably 160 g or more, more preferably 230 g or more, and even more preferably 270 g or more. The upper limit is preferably 550 g or less, more preferably 450 g or less, and even more preferably 380 g or less. By setting the roll weight within the above numerical range, it is possible to provide a kitchen towel roll 1 in which the basis weight, strength, and water absorption amount are maintained within certain ranges.

Furthermore, the lower limit of the roll weight per 280 mm of roll width of the kitchen towel roll 1 is preferably 160 g or more, more preferably 230 g or more, and even more preferably 270 g or more. The upper limit is preferably 550 g or less, more preferably 450 g or less, and even more preferably 380 g or less. By setting the roll weight per 280 mm of roll width within the above numerical range, it is possible to provide a kitchen towel roll 1 in which the basis weight, strength, and water absorption amount are maintained within certain ranges.

The above roll weight in each case refers to the weight excluding the core (also referred to as paper tube or core) in the kitchen towel roll 1. If the roll width is not 280 mm, the roll weight per 280 mm of roll width is converted by proportional calculation.

### (Roll Density)

The lower limit of the roll density of the kitchen towel roll 1 according to the present embodiment is preferably 0.04 g/cm³ or more, more preferably 0.05 g/cm³ or more, and even more preferably 0.06 g/cm³ or more. The upper limit is preferably 0.15 g/cm³ or less, more preferably 0.13 g/cm³ or less, and even more preferably 0.09 g/cm³ or less. By setting the roll density within the above numerical range, it is possible to provide a kitchen towel roll 1 that has a soft tactile feel and also has firmness.

The roll density is expressed as (roll weight)=(roll volume). The roll weight is the weight of the kitchen towel roll 1 per 280 mm of roll width. The roll volume is expressed as [{cross-sectional area of the outer diameter (wound diameter DR) of the roll}-{cross-sectional area of the core outer diameter DI}]×roll width (converted to per 280 mm). For example, if the roll weight per 280 mm of roll width (excluding the core) is 382 g, the wound diameter DR is 150 mm, and the core outer diameter DI is 39 mm, then roll density=382 g÷[{3.14×(150 mm÷2÷10)²−3.14×(39 mm÷2÷10)²}×(280 mm÷10)]=0.08 g/cm³.

### (Winding Density)

The lower limit of the winding density of the kitchen towel roll 1 according to the present embodiment is preferably 0.22 m/cm² or more, more preferably 0.25 m/cm² or more, and even more preferably 0.28 m/cm² or more. The upper limit is preferably 0.68 m/cm² or less, more preferably 0.54 m/cm² or less, and even more preferably 0.40 m/cm² or less. By setting the winding density of the kitchen towel roll 1 within the above numerical range, it is possible to provide a kitchen towel roll 1 that has a soft tactile feel and also has firmness.

The winding density is expressed as (wound length×number of plies)÷(cross-sectional area of the roll). The cross-sectional area of the roll is expressed as {cross-sectional area of the outer diameter (wound diameter DR) of the roll-cross-sectional area of the core outer diameter DI}. For example, if the wound length is 27 m, 2 plies, wound diameter DR is 150 mm, and core outer diameter DI is 39 mm, then winding density=(27 m×2)÷{3.14× (150 mm÷2÷10)²−3.14× (39 mm÷2÷10)²}=0.33 m/cm².

Further, when the winding density of the initial portion (1% or more and 33% or less) of the roll in the kitchen towel roll 1 is a, the winding density of the intermediate portion (34% or more and 66% or less) is b, and the winding density of the end portion (100%) is c, (a/c)×100(%) preferably has a lower limit of 90% or more, more preferably 95% or more, and even more preferably 100% or more. The upper limit is preferably 130% or less, more preferably 120% or less, and even more preferably 110% or less.

Similarly, (b/c)×100(%) preferably has a lower limit of 95% or more, more preferably 98% or more, and even more preferably 100% or more. The upper limit is preferably 120% or less, more preferably 115% or less, and even more preferably 110% or less.

If (a/c)×100(%) is less than 90% or (b/c)×100(%) is less than 95%, wrinkles may form in the kitchen towel sheet 1x, resulting in reduced wiping performance. If (a/c)×100(%) exceeds 130% or (b/c)×100(%) exceeds 120%, the embossment may be crushed, resulting in reduced water absorption or making wiping more difficult. At this time, the winding density c of the end portion is the winding density in an unused kitchen towel roll 1.

The winding density in each portion is determined by unwinding the kitchen towel sheet 1x in fixed lengths (for example, 50 cm) and measuring the roll diameter at the time of unwinding, then calculating the winding density. At this time, in the above formula, the “wound length” is calculated by subtracting the “unwound length” from the “wound length of the kitchen towel roll 1.” This operation is repeated to determine the winding density b of the intermediate portion and the winding density a of the initial portion.

The range from the start to the end of winding of the roll is expressed as 1% to 100%, where 0% corresponds to the outermost edge of the core outer diameter (core outer diameter DI) described below. The winding density in each portion can be controlled by adjusting the timing of acceleration and deceleration of the winding speed and the nip pressure of the rider roll during winding processing with a roll winder at the time of manufacturing the kitchen towel roll 1.

### (Softness of Wound Roll)

The softness of the wound kitchen towel roll 1 according to the present embodiment is preferably 1.2 mm or more and 4.0 mm or less. By setting the wound softness within the above numerical range, it is possible to provide a kitchen towel roll 1 that has a soft tactile feel and also has firmness. The lower limit is more preferably 1.5 mm or more, and even more preferably 1.7 mm or more. The upper limit is more preferably 3.5 mm or less, and even more preferably 3.0 mm or less.

In the kitchen towel roll 1 of the present disclosure, as described above, since the kitchen towel roll 1 has a long wound length, when evaluating the softness of the kitchen towel roll 1, the above wound softness is evaluated to assess the softness when the kitchen towel roll 1 is held in the hand.

The softness of the wound kitchen towel roll 1 is measured as follows using a compression tester (Handy Compression Tester KES-G5 manufactured by Kato Tech Co., Ltd.). The direction parallel to the axis of the kitchen towel roll 1 is defined as the height direction, and the direction perpendicular to the tangent of the circumference of the kitchen towel roll 1 is defined as the radial direction.

First, the kitchen towel roll 1 is placed horizontally on a hard table so that its axis is horizontal. Then, the compressor (area: 2.0 cm²) of the above KES-G5 is pressed from above in the radial direction at a speed of 10 mm/min at the center in the height direction of the kitchen towel roll 1. The indentation depth when the pressure applied by the head of the compressor to the roll is 5 gf/cm² is defined as TO, and the indentation depth when the pressure is 150 gf/cm² is defined as Tm, and (Tm-T0) is determined. Next, the kitchen towel roll 1 is rotated 90 degrees circumferentially with its axis as the axis of rotation, and the indentation depths Tm and T0 are measured in the same manner as above, and the difference (Tm−T0) is determined. For one kitchen towel roll, the above measurement is performed twice. That is, for three kitchen towel rolls 1, each is measured twice, and the average of the total six measurements (=2 times/roll×3 rolls) is taken as the final wound softness.

### (Core Outer Diameter)

Further, the lower limit of the core outer diameter DI, which is the outer diameter of the core of the kitchen towel roll 1 of the present disclosure, is preferably 30 mm or more, more preferably 35 mm or more, and even more preferably 40 mm or more. The upper limit is preferably 60 mm or less, more preferably 55 mm or less, and even more preferably 50 mm or less. By setting the core outer diameter DI within the above numerical range, it is possible to provide a kitchen towel roll 1 that has a soft tactile feel and also has firmness.

The core outer diameter DI is measured using “a diameter rule” manufactured by Muratec KDS Co., Ltd. Three kitchen towel rolls 1 are measured, and the average of the measurement results is used. If there is no core (paper tube) in the core, the outer diameter of the hollow core portion is measured.

Furthermore, the lower limit of the apparent basis weight of the paper tube serving as the core is preferably 300 g/m² or more, more preferably 320 g/m² or more, and even more preferably 350 g/m² or more. The upper limit is preferably 550 g/m² or less, more preferably 500 g/m² or less, and even more preferably 450 g/m² or less. By setting the apparent basis weight of the paper tube within the above numerical range, it is possible to provide a kitchen towel roll 1 that has a soft tactile feel and also has firmness.

Further, the lower limit of the weight of the paper tube per 280 mm of roll width serving as the core is preferably 7 g, more preferably 10 g, and even more preferably 13 g. The upper limit is preferably 25 g or less, more preferably 22 g or less, and even more preferably 18 g or less. By setting the weight of the paper tube per 280 mm of roll width within the above numerical range, it is possible to provide a kitchen towel roll 1 in which the basis weight, strength, and water absorption amount are maintained within certain ranges.

The above weight of the paper tube is converted to the weight per 280 mm if the roll width is not 280 mm by proportional calculation.

The base paper used for the paper tube serving as the core may be composed of 100 mass % wood pulp, and may include recycled fiber, non-wood pulp, deinked pulp, waste paper from liquid beverage paper packs, etc. However, from the viewpoint of quality, the mass content of pulp other than wood pulp or recycled fiber, etc., is preferably 50% or less, more preferably 30% or less, even more preferably 10% or less, and most preferably 0%.

To achieve the target quality, the weight content of NBKP (bleached softwood kraft pulp) is preferably 0% or more and 50% or less, more preferably 0% or more and 30% or less, and even more preferably 0% or more and 10% or less. Further, the mass content of LBKP (Bleached hardwood kraft pulp) is preferably 50% or more and 100% or less, more preferably 70% or more and 100% or less, and even more preferably 90% or more and 100% or less.

### <Kitchen Towel Sheet>

### (Basis Weight)

The basis weight of one ply of the kitchen towel sheet 1x according to the present embodiment is 16 g/m² or more and 27 g/m² or less. If the basis weight of one ply is less than 16 g/m², the kitchen towel sheet 1x is inferior in water absorption. If the basis weight of one ply exceeds 27 g/m², the manufacturing cost increases.

The basis weight of the kitchen towel sheet 1x can be measured in accordance with JIS P 8124. The lower limit of the basis weight of one ply of the kitchen towel sheet 1x is preferably 18 g/m² or more, more preferably 20 g/m² or more. The upper limit is preferably 25 g/m² or less, more preferably 23 g/m² or less.

### (Paper Thickness)

The paper thickness of the kitchen towel sheet 1x is preferably 1.3 mm/10 plies or more and 5.0 mm/10 plies or less. If the paper thickness is less than 1.3 mm/10 plies, the kitchen towel sheet 1x is inferior in water absorption and firmness. If the paper thickness exceeds 5.0 mm/10 plies, the manufacturing cost increases.

The paper thickness can be measured using a thickness gauge (dial thickness gauge “PEACOCK” manufactured by Ozaki Mfg. Co., Ltd.). The measurement conditions are a measurement load of 37.85 gf/cm² and a measurement head diameter of 30 mm. The sample is placed between the measurement head and the measurement table, and the gauge is read when the measurement head is lowered at a speed of 1 mm or less per second. As a sample, the kitchen towel sheet 1x is measured as 10 plies (five sets of two plies). The measurement is repeated 10 times at different locations, and the average of the measurement results is used.

The lower limit of the paper thickness of the kitchen towel sheets 1x is more preferably 2.0 mm/10 plies or more, and even more preferably 2.6 mm/10 plies or more. The upper limit is more preferably 4.4 mm/10 plies or less, and even more preferably 3.8 mm/10 plies or less.

### (Specific Volume)

The specific volume of the kitchen towel sheet 1x is preferably 7.6 cm³/g or more and 19.2 cm³/g or less. If the specific volume of the kitchen towel sheet 1x is less than 7.6 cm³/g, the kitchen towel sheet 1x is inferior in softness. If the specific volume of the kitchen towel sheet 1x exceeds 19.2 cm³/g, the kitchen towel sheet 1x is inferior in firmness.

The lower limit of the specific volume of the kitchen towel sheet 1x is more preferably 11.1 cm³/g or more, and even more preferably 12.4 cm³/g or more. The upper limit is more preferably 17.6 cm³/g or less, and even more preferably 16.5 cm³/g or less. The specific volume is expressed as the paper thickness per ply of the kitchen towel sheet 1x divided by the basis weight per ply, and is represented as the volume (cm³) per unit (g).

### (DMDT, DCDT, and GMT)

The DMDT (Dry Machine Direction Tensile Strength) of the kitchen towel sheet 1x based on JIS P 8113 is 600 gf/25 mm or more and 1500 gf/25 mm or less.

Further, the DCDT (Dry Cross Direction Tensile Strength) of the kitchen towel sheet 1x based on JIS P 8113 is 600 gf/25 mm or more and 1500 gf/25 mm or less.

If DMDT or DCDT is less than 600 gf/25 mm, the kitchen towel sheet 1x is inferior in firmness and tear resistance. If DMDT or DCDT exceeds 1500 gf/25 mm, the kitchen towel sheet 1x becomes hard and inferior in softness.

The lower limit of DMDT is preferably 720 gf/25 mm or more, more preferably 800 gf/25 mm or more. The upper limit is preferably 1350 gf/25 mm or less, more preferably 1200 gf/25 mm or less.

Further, the lower limit of DCDT is preferably 720 gf/25 mm or more, more preferably 800 gf/25 mm or more. The upper limit is preferably 1350 gf/25 mm or less, more preferably 1200 gf/25 mm or less.

Furthermore, the GMT, which is the square root of the product of DMDT and DCDT, preferably has a lower limit of 600 gf/25 mm or more, more preferably 720 gf/25 mm or more, and even more preferably 800 gf/25 mm or more. The upper limit is preferably 1500 gf/25 mm or less, more preferably 1350 gf/25 mm or less, and even more preferably 1200 gf/25 mm or less.

If GMT is less than 600 gf/25 mm, the kitchen towel sheet 1x is inferior in firmness and tear resistance. If GMT exceeds 1500 gf/25 mm, the kitchen towel sheet 1x becomes hard and inferior in softness.

Further, the ratio of DMDT to DCDT (DMDT/DCDT) is 0.3 or more and 2.5 or less. If the ratio is less than 0.3, while DMDT remains within a certain range, DCDT becomes high, resulting in the kitchen towel sheet 1x being inferior in softness. If the ratio exceeds 2.5, while DCDT remains within a certain range, DMDT becomes high, resulting in the kitchen towel sheet 1x being inferior in softness.

The lower limit of the ratio of DMDT to DCDT (DMDT/DCDT) is preferably 0.5 or more, and more preferably 0.7 or more. The upper limit is preferably 1.5 or less, and more preferably 1.3 or less.

The DMDT and DCDT of the kitchen towel sheet 1x are measured in a two-ply state in accordance with JIS P 8113, and the ratio (DMDT/DCDT) is calculated from the measured DMDT and DCDT. Further, GMT is calculated as the square root of the product of the measured DMDT and DCDT.

### (WMDT and WCDT)

The WMDT (Wet Machine Direction Tensile Strength) of the kitchen towel sheet 1x based on former JIS S 3104 (1999) preferably has a lower limit of 190 gf/25 mm or more, more preferably 240 gf/25 mm or more, and still more preferably 270 gf/25 mm or more. The upper limit is preferably 540 gf/25 mm or less, more preferably 480 gf/25 mm or less, and still more preferably 430 gf/25 mm or less.

Further, the WCDT (Wet Cross Direction Tensile Strength) of the kitchen towel sheet 1x based on former JIS S 3104 (1999) preferably has a lower limit of 190 gf/25 mm or more, more preferably 240 gf/25 mm or more, and still more preferably 270 gf/25 mm or more. The upper limit is preferably 540 gf/25 mm or less, more preferably 480 gf/25 mm or less, and still more preferably 430 gf/25 mm or less.

If WMDT is less than 190 gf/25 mm or WCDT is less than 190 gf/25 mm, in either case, the kitchen towel sheet 1x is inferior in firmness and tear resistance. If WMDT exceeds 540 gf/25 mm or WCDT exceeds 540 gf/25 mm, in either case, the kitchen towel sheet 1x is inferior in softness as a result.

Further, the ratio of WMDT to WCDT (WMDT/WCDT) preferably has a lower limit of 0.3 or more, more preferably 0.5 or more, and still more preferably 0.7 or more. The upper limit is preferably 2.5 or less, more preferably 1.5 or less, and still more preferably 1.3 or less.

If the ratio is less than 0.3, either WMDT remains within a certain range while WCDT becomes high, resulting in the kitchen towel sheet 1x being inferior in softness, or WMDT becomes low, resulting in the kitchen towel sheet 1x being inferior in firmness and tear resistance. If the ratio exceeds 2.5, either WCDT remains within a certain range while WMDT becomes high, resulting in the kitchen towel sheet 1x being inferior in softness, or WCDT becomes low, resulting in the kitchen towel sheet 1x being inferior in firmness and tear resistance.

The WMDT and WCDT of the kitchen towel sheet 1x are measured in a two-ply state in accordance with former JIS S 3104 (1999).

### (Elongation)

Furthermore, the MD-direction elongation of the kitchen towel sheet 1x based on JIS P 8113 is preferably 6% or more and 15% or less. If the MD-direction elongation of the kitchen towel sheet 1x is less than 6%, the kitchen towel sheet 1x becomes hard as a result and is inferior in softness. If the MD-direction elongation of the kitchen towel sheet 1x exceeds 15%, the kitchen towel sheet 1x is inferior in firmness as a result.

The lower limit of the MD-direction elongation of the kitchen towel sheet 1x is preferably 8% or more, and still more preferable 10% or more. The upper limit is more preferably 14% or less, and still more preferably 13% or less.

Further, the CD-direction elongation of the kitchen towel sheet 1x based on JIS P 8113 is preferably 3% or more and 10% or less. If the CD-direction elongation of the kitchen towel sheet 1x is less than 3%, the kitchen towel sheet 1x becomes hard as a result and is inferior in softness. If the CD-direction elongation of the kitchen towel sheet 1x exceeds 10%, the kitchen towel sheet 1x is inferior in firmness as a result.

The lower limit of the CD-direction elongation of the kitchen towel sheet 1x is more preferably 4% or more, and still more preferable 5% or more. The upper limit is more preferably 8% or less, and still more preferably 6% or less.

The elongation in each direction of the kitchen towel sheet 1x can be measured in accordance with the method described in JIS P 8113.

### (Bending Resistance)

The bending resistance of the kitchen towel sheet 1x in both the MD direction and the CD direction is 4.5 mN or more and 22.0 mN or less. If the bending resistance in either the MD direction or the CD direction of the kitchen towel sheet 1x is less than 4.5 mN, the basis weight and strength of the kitchen towel sheet 1x become low, resulting in inferiority in firmness and tear resistance. If the bending resistance in either the MD direction or the CD direction of the kitchen towel sheet 1x exceeds 22.0 mN, the kitchen towel sheet 1x becomes hard and is inferior in softness.

The lower limit of the bending resistance in both the MD direction and the CD direction of the kitchen towel sheet 1x is preferably 7.5 mN or more, and more preferably 10.5 mN or more. Further, the upper limit in both directions is preferably 17.5 mN or less, and more preferably 15.5 mN or less.

The bending resistance in each direction of the kitchen towel sheet 1x can be measured in accordance with the method described in JIS P 8125-1:2017 (ISO2493), using an L&W Bending Tester (manufactured by Lorentzen & Wettre Co., Ltd.). For a test piece of the kitchen towel sheet 1x having a width of 38 mm and a length of 100 mm, the measured value in each direction when the bending angle is degrees and the bending length (span of the specimen table) is 10 mm is taken as the bending resistance (load). The above measurement is performed in a two-ply state for each of the MD direction and the CD direction.

If the perforation interval of the sheet is short and a test piece with a length of 100 mm cannot be obtained, the length of the test piece may be shortened.

### (Peel Strength)

Further, the peel strength of the kitchen towel sheet 1x is preferably 0.03 N/100 mm or more and 0.5 N/100 mm or less. If the peel strength of the kitchen towel sheet 1x is less than 0.03 N/100 mm, the kitchen towel sheet 1x becomes prone to ply separation and is inferior in firmness. If the peel strength of the kitchen towel sheet 1x exceeds 0.5 N/100 mm, the kitchen towel sheet 1x becomes hard and is inferior in softness.

The lower limit of the peel strength of the kitchen towel sheet 1x is preferably 0.1 N/100 mm or more, and still more preferable 0.2 N/100 mm or more. The upper limit is more preferably 0.4 N/100 mm or less, and still more preferably 0.35 N/100 mm or less. The peel strength of the kitchen towel sheet 1x is measured as described below.

The measurement of peel strength is performed in accordance with the tensile test method of JIS P 8113, using a tensile tester (STB-1225S, manufactured by A&D Company, Limited), under the standard conditions specified in JIS P 8111.

First, three rectangular test pieces of 65 mm×100 mm are taken from a sample of the kitchen towel sheet 1x. At this time, in order to vary the flow direction and width direction of the sheet, for example, one piece in the MD direction, one piece in the CD direction, and one piece in an oblique direction intermediate between the MD and CD directions are taken, and the plies are peeled 15 mm in the short side (65 mm) direction. At this time, the unpeeled portion is 50 mm. Next, two acrylic plates or the like are provided and sandwiched between the upper and lower grips. The distance (gap) between the two acrylic plates sandwiched in the upper and lower grips is set to 1 mm, which is sufficient for the sheet to be inserted between the upper and lower grips. The acrylic plates may be of any size as long as they are larger than the grips and the test piece, but if they are rectangular with dimensions of about 85 mm×110 mm, it is easy to set the test piece. Next, one side of the peeled ply is affixed and fixed to the upper acrylic plate with tape or the like. The other ply is also affixed and fixed to the lower acrylic plate with tape or the like. The tape should be longer than 100 mm and should firmly fix the entire long side (100 mm) of the test piece. If the acrylic plates are rectangular with dimensions of 85 mm×110 mm, it is preferable to affix the tape to the 110 mm side. Next, the test piece is pulled (peeled) 50 mm at a pulling speed of 100 mm/min, and strength data are collected. The strength data are analyzed by graph analysis, and the peak analysis range is selected. The peak analysis range is selected so as to exclude the first 10% immediately after measurement and the last 10% immediately before the end of measurement, and this is taken as the peel strength (N/100 mm).

### (Water Absorption Amount)

In the present disclosure, the water absorption amount per unit area of the kitchen towel sheet 1x is 330 g/m² or more and 600 g/m² or less. If the water absorption amount per unit area is less than 330 g/m², the kitchen towel sheet 1x is inferior in water absorbency. If the water absorption amount per unit area exceeds 600 g/m², the basis weight of the kitchen towel sheet 1x becomes high, resulting in increased cost.

The lower limit of the water absorption amount per unit area of the kitchen towel sheet 1x is preferably 400 g/m² or more, and more preferably 420 g/m² or more. The upper limit is preferably 500 g/m² or less, and more preferably 460 g/m² or less.

Further, the water absorption amount per unit weight of the kitchen towel sheet 1x is preferably 6 g/g or more, more preferably 8 g/g or more, and still more preferably 10 g/g or more. The upper limit is preferably 18 g/g or less, more preferably 15 g/g or less, and still more preferably 13 g/g or less.

If the water absorption amount per unit weight is less than 6 g/g, the kitchen towel sheet 1x is inferior in water absorbency. If the water absorption amount per unit weight exceeds 18 g/g, the water absorption amount per sheet becomes unnecessarily large, or the manufacturing cost increases.

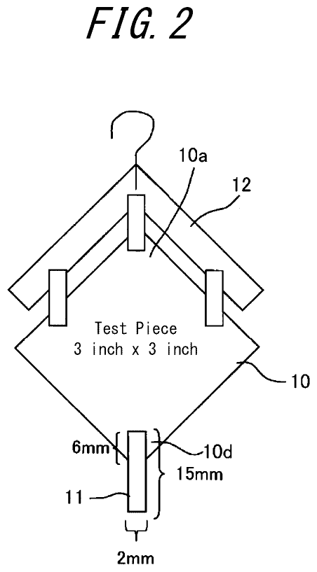

The measurement method for each water absorption amount of the kitchen towel sheet 1x will be described below with reference to FIG. 2.

First, a kitchen towel sheet 1x laminated in two plies is taken, and using a square template with a side of 7.6 cm (3 inches), a rectangular test piece 10 with a side of 7.6 cm is prepared by cutting. The weight of the test piece 10 before water absorption is measured with an electronic balance. The test piece 10 is set in a holder 12 (a jig that fixes three points of the test piece, made of a metal that does not absorb water).

Next, distilled water is poured into a commercially available tray to a depth of 2 cm, and the test piece 10 set in the holder 12 is immersed in the distilled water for 2 minutes. After 2 minutes of immersion, the test piece 10 is taken out of the distilled water together with the holder 12, and as illustrated in FIG. 2, a strip 11 is affixed to one corner 10d of the test piece 10. The strip 11 is prepared by peeling one ply from the same kitchen towel as the two-ply kitchen towel to be measured, cutting the paper kitchen towel ply into a size of 2 mm×15 mm, and affixing it to a portion 6 mm from the corner 10d of the test piece 10 toward the center. Next, the holder 12 and the test piece are suspended from a rod installed in an empty water tank so that the corner 10a opposite to the corner 10d is on top, and the lid of the water tank is closed and left to stand for 15 minutes.

Thereafter, the holder 12 and the test piece 10 are taken out from the water tank, the strip 11 and the holder 12 are removed, and the weight of the test piece 10 is measured with an electronic balance. The amount of distilled water absorbed per unit area (water g/sheet m², per 1 m², hereinafter abbreviated as g/m²) of the test piece 10 is calculated from the change in weight of the test piece 10 before and after immersion in distilled water. Further, by dividing the water absorption amount per unit area (water g/sheet m²) by the basis weight of the product ply of the test piece 10, the water absorption amount per unit weight (water g/sheet g, per 1 g, hereinafter abbreviated as g/g) is calculated as (water g/sheet m²)/(sheet g/sheet m²). The measurement is performed five times for each sample, and the average value is adopted.

This measurement is performed in accordance with the JIS P 8111 method, under conditions of temperature 23±1° C. and humidity 50±2%. The distilled water is also maintained at 23±1° C.

### (Emboss)

The kitchen towel roll 1 (kitchen towel sheet 1x) according to the present embodiment is provided with embossing and has an emboss pattern. Further, the kitchen towel sheet 1x in the present disclosure is formed by embossing one or both of the two-ply sheets and then laminating to form a two-ply structure. When laminated into two plies, bonding is performed with ply bond glue (adhesive) or water, with ply bond glue being preferable. By bonding in this manner to form a two-ply structure, the adhesion between plies is strengthened, and even when the kitchen towel sheet 1x becomes wet, ply separation is prevented and tearing is less likely to occur.

It is preferable that the embossing is applied to one of the two-ply sheets, and more preferably to the ply on the surface 1a of the two-ply sheets.

As described above, it is preferable that the ply on the surface 1a of the kitchen towel sheet 1x is provided with an emboss pattern. By providing the emboss pattern on the surface 1a, glue can be applied to the embossed portions of the emboss pattern for bonding, making ply separation of the kitchen towel sheet 1x less likely to occur and enabling the water absorption amount to be kept within a certain range.

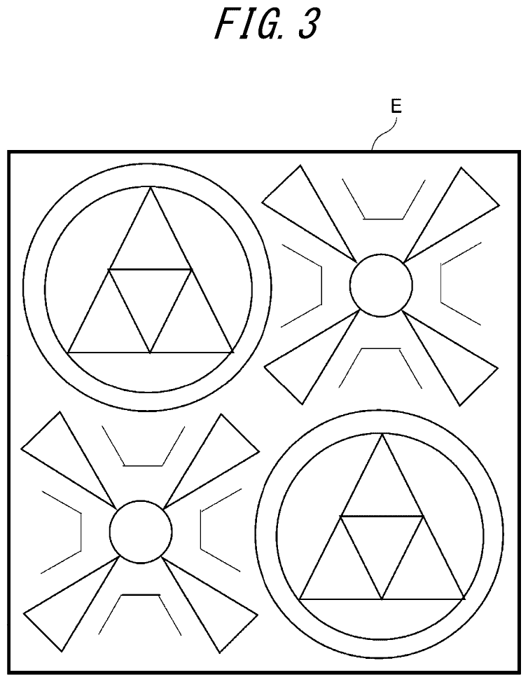

The emboss pattern is not particularly limited as long as it is a pattern generally applied to kitchen towels, such as a dot or linear pattern, but a linear emboss pattern is preferable among them. As a specific example of a linear emboss pattern, as illustrated in FIG. 3, a pattern may include two types of shapes, each pattern including two of each: a substantially round, substantially circular shape with another design inside, and a shape that is substantially line-symmetrical vertically and horizontally as a whole and includes a combination of multiple curves and shapes. The substantially round, substantially circular shape is preferably double circles.

Further, as for the dimensions of the emboss pattern, the square E (E is not the emboss pattern) surrounding the emboss pattern is preferably a square with a side of 2 cm or more and 25 cm or less, more preferably a square with a side of 5 cm or more and 20 cm or less, and still more preferably a square with a side of 8 cm or more and 15 cm or less. For this square E, it is preferable that the vertical direction is parallel to the flow direction of the kitchen towel roll 1, and the horizontal direction is parallel to the width direction of the kitchen towel roll 1, but it may be inclined. By using such a pattern, in a kitchen towel sheet 1x with a high water absorption amount as in the present application, the water absorption amount can be improved, ply separation is less likely to occur, and strength can be maintained, resulting in firmness.

At this time, it is preferable that, in the linear emboss pattern, the area occupied by embossed parts having a width of 0.1 mm or more and 4 mm or less and a length of 5 mm or more accounts for 4% or more and 50% or less of the area of the kitchen towel sheet 1x. If the ratio is less than 4%, the kitchen towel sheet 1x is inferior in firmness and becomes prone to tearing. If the proportion exceeds 50%, the kitchen towel sheet 1x is inferior in softness.

The above area ratio is determined as follows: within the square E that includes the entire emboss pattern as illustrated in FIG. 3, for embossed parts having a width of 0.1 mm or more and 4 mm or less and a length of 5 mm or more, the total length is measured by summing the lengths of the embossed parts, and the area of the embossed parts is obtained as total length (mm)× width (mm). The area of one sheet of the kitchen towel sheet 1x is taken as (sheet length× sheet width), and the ratio is calculated as (emboss area/area of one sheet of kitchen towel sheet 1x)×100(%).

The size of one side of the square E can be appropriately changed depending on the size of the emboss pattern. If an emboss pattern adjacent to the emboss pattern included in the square is also included within the square, the length of the adjacent emboss pattern is also measured and included in the total length. If the size of one side of the square E cannot be clearly determined due to the emboss pattern, the size of the square E is set to 10×10 cm, and the total length of the embossed parts included in this square E is measured. The total length is determined by actual measurement using a ruler, tape measure, or the like as described above. If visual observation of the embossed parts is difficult, measurement may be performed using a general microscope.

Further, the ratio of the area occupied by embossed parts in the linear emboss pattern having a width of 0.1 mm or more and 4 mm or less and a length of 5 mm or more with respect to the area of the kitchen towel sheet 1x is more preferably 6% or more, and still more preferable 9% or more. The upper limit is more preferably 35% or less, and still more preferably 16% or less.

In the emboss pattern, it is preferable that the emboss depth is 0.06 mm or more and 1.05 mm or less. If the emboss depth is less than 0.06 mm, the kitchen towel sheet 1x is inferior in softness. If the depth exceeds 1.05 mm, the kitchen towel sheet 1x is inferior in firmness and tear resistance.

The lower limit of the emboss depth in the emboss pattern is more preferably 0.10 mm or more, and still more preferably 0.14 mm or more. The upper limit is more preferably 0.55 mm or less, and still more preferably 0.35 mm or less.

The emboss depth is measured using a microscope. As the microscope, a product named “3D Optical Profilometer VR-3100” manufactured by KEYENCE Corporation can be used. As the image observation, measurement, and image analysis software for the microscope, a product named “VR-HIA” can be used. The measurement conditions are a magnification of 25× and a field of view area of 12 mm×9 mm. The measurement magnification and field of view area may be appropriately changed depending on the size of the embossments to be measured.

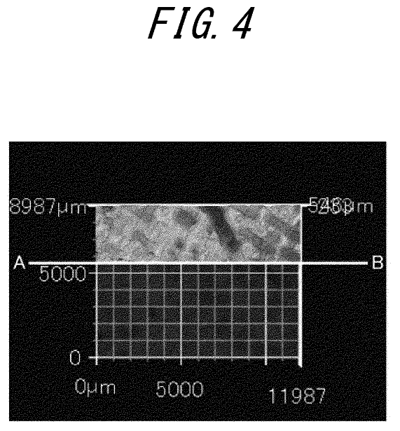

FIG. 4 illustrates a height profile on the X-Y plane obtained by a microscope, in which the height of the surface of the kitchen towel sheet 1x is represented by shading intensity. The linear regions in FIG. 4 where the shading differs from the surrounding areas indicate individual embossed parts. The emboss depth is determined by measuring the height difference of the aforementioned embossed parts using the above-described microscope. The measurement is performed on the surface 1a side of the kitchen towel sheet 1x. In addition, at the time of measurement, three turns of the kitchen towel sheet 1x are removed from the kitchen towel roll 1, and the fourth turn of the kitchen towel sheet 1x is used, with the measurement conducted in the state of a two-ply sheet. Furthermore, if there are perforations, all such areas are avoided during measurement.

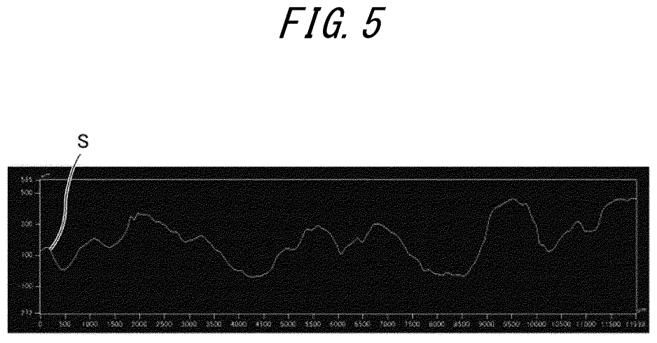

First, as illustrated in FIG. 4, a line segment AB is drawn to obtain the height profile illustrated in FIG. 5. The line segment AB may be drawn so as to cross the embossed part. The line segment AB is drawn in the width direction (CD direction) of the kitchen towel sheet 1x; however, if the interval between embossed parts is, for example, 2 mm or less and the height of the protrusions described below becomes low, the line segment may be drawn in an oblique direction or in the machine direction (MD direction). The height profile in FIG. 5 is a (measured) cross-sectional curve S representing the actual surface irregularities of the sample of the kitchen towel sheet 1x, but it also includes noise (such as fiber clumps on the surface of the kitchen towel sheet 1x, fibers extending in a whisker-like manner, or steep peaks caused by areas without fibers). When calculating the height difference of the irregularities, it is necessary to remove such noise peaks.

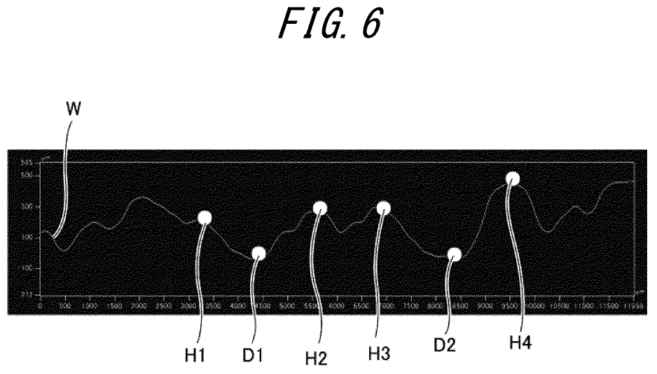

Therefore, the (measured) cross-sectional curve S in FIG. 5 is smoothed using an average weight filter with a filter size of +12, thereby obtaining the smoothed cross-sectional curve W illustrated in FIG. 6. The smoothing using the weighted moving average filter can be automatically performed by using the above-mentioned analysis software. Then, in the graph illustrated in FIG. 6, the average of the maximum values on the vertical axis of the protrusion H1 and the adjacent protrusion H2 is calculated, and the minimum value on the vertical axis at the depression DI sandwiched between the protrusions H1 and H2 is determined. The value obtained by subtracting this minimum value from the average of the maximum values thus obtained is taken as the provisional emboss depth. As illustrated in FIG. 6, similar measurements are performed at a total of two consecutive locations on the cross-sectional curve (the depression D1 and the depression D2 sandwiched between the protrusions H3 and H4), resulting in two measurement results at this stage. Thereafter, the kitchen towel roll 1 is rotated three times by 90 degrees each in the machine direction of the kitchen towel sheet 1x, and similar measurements are performed at each position (resulting in a total of four measurement positions in the machine direction), and the average value of a total of eight locations (2× 4) is finally adopted as the emboss depth.

It should be noted that the kitchen towel sheet 1x of the present disclosure has an uneven pattern originating from the papermaking process that is different from the emboss pattern, so there may be variations in the heights of the protrusions on the left and right sides of the depression. Therefore, if the difference in the vertical axis values of the protrusions sandwiching the depression (for example, the protrusions H3 and H4 sandwiching the depression D2) is 0.2 mm or more, the measurement is performed at a location avoiding that part.

Further, the root mean square height Sq of surface roughness in a portion of the kitchen towel sheet 1x where the emboss pattern is not imparted (hereinafter also referred to as the non-embossed portion) is preferably 35 μm or more and 170 μm or less. If the root mean square height Sq of surface roughness is less than 35 μm, the specific surface area of the surface layer becomes small, making it likely that water absorbency will be low. If the root mean square height Sq of surface roughness exceeds 170 μm, the surface layer is likely to tear during wiping, resulting in a lack of firmness.

The lower limit of the root mean square height Sq of surface roughness is more preferably 50 μm or more, and even more preferably 60 μm or more. The upper limit is more preferably 150 μm or less, and even more preferably 100 μm or less.

The root mean square height Sq of surface roughness in the non-embossed portion is measured using a microscope. As the microscope, the product name “3D Optical Profilometer e VR-3100” manufactured by KEYENCE Corporation can be used, as with the above-described emboss depth. As the image observation, measurement, and image analysis software for the microscope, the product name “VR-HIA” can be used. The measurement conditions are a magnification of 38× and a field of view area of 8 mm×6 mm. The measurement magnification and field of view area may be appropriately changed depending on the size of the embossment to be measured.

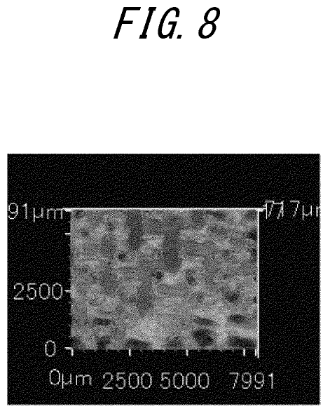

For the obtained image illustrated in FIG. 8, a filter is set in the same manner as for the above-described emboss depth. Specifically, by setting an S-filter (low-pass filter), components of a scale smaller than the cutoff wavelength are removed from the image, and by setting an L-filter (high-pass filter), components of a scale larger than the cutoff wavelength are removed from the image. Here, the S-filter is set to 500 μm, and the L-filter is set to 8 mm. By selecting the S-filter and L-filter, the root mean square height Sq is automatically calculated.

For the non-embossed portion, as with the emboss depth, three turns of the kitchen towel sheet 1x are removed from the kitchen towel roll 1, and the fourth turn of the kitchen towel sheet 1x is used, with the measurement conducted in the state of a two-ply sheet. Furthermore, if there are perforations, all such areas are avoided during measurement. Measurements are taken at two locations in the width direction of the kitchen towel roll 1, and then, at each position where the kitchen towel roll 1 is rotated three times by 90 degrees each in the machine direction of the kitchen towel sheet 1x, similar measurements are performed (resulting in a total of four measurement positions in the machine direction), and the average value of a total of eight locations (2× 4) is finally adopted as the root mean square height Sq.

### <Method for Manufacturing Kitchen Towel Roll>

The kitchen towel roll 1 according to the present embodiment can be manufactured, for example, in the order of (1) papermaking and creping, (2) embossing and bonding, and (3) roll winding. In the manufacturing (papermaking) process of the kitchen towel sheet 1x, it is preferable to use TAD papermaking technology.

At this time, in the papermaking process, it is preferable that an uneven pattern originating from the papermaking process (fabric) that is different from the above-described emboss pattern is imparted to the kitchen towel sheet 1x. By having this pattern of irregularities, the water absorption amount of the kitchen towel sheet 1x is further increased.

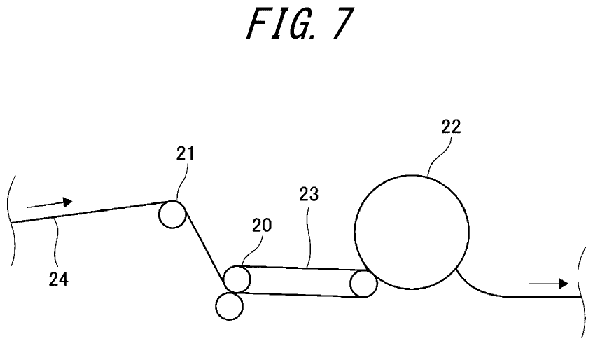

Here, “originating from the papermaking process” means that an uneven pattern is imparted in the papermaking process of the kitchen towel sheet 1x, from the headbox of the papermaking machine to the exit of the Yankee dryer 22. Specifically, in a part of the papermaking process illustrated in FIG. 7, irregularities can be imparted at the belt press portion 20, which is disposed between the dewatering roll 21 and the Yankee dryer 22. At the belt press portion 20, by pressing the wet paper 24 together with the textured belt 23 (the textured belt 23 loops between the belt press portion 20 and the Yankee dryer 22), an uneven pattern can be imparted to the wet paper 24.

Furthermore, the pattern of irregularities can be appropriately changed by changing the pattern of the fabric (fine pattern, coarse pattern). Changing the pattern of irregularities changes the specific volume (paper thickness), but it is preferable to select a pattern such that the specific volume in the roll state is within the above-described numerical range.

### (Kitchen Towel Roll Package)

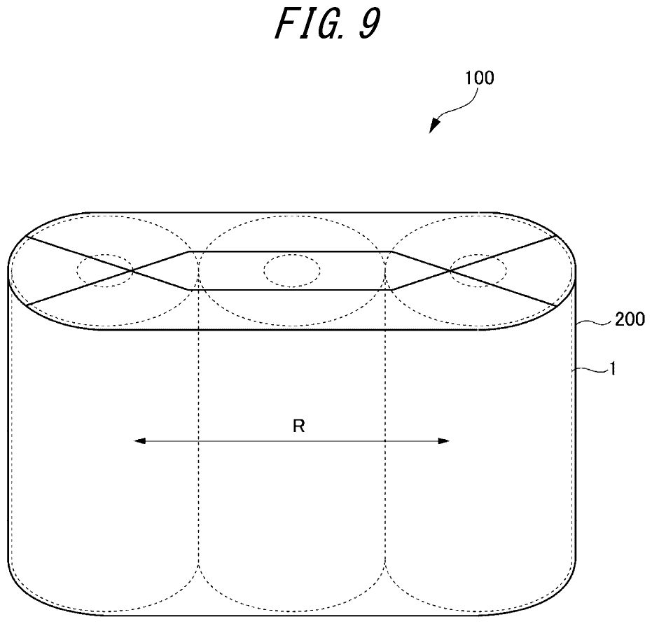

Furthermore, the kitchen towel roll 1 according to the present embodiment can also be manufactured and sold in the form of a kitchen towel roll package 100, in which, as illustrated in FIG. 9, three kitchen towel rolls 1 are arranged adjacent to each other with their axial directions substantially parallel, and wrapped with a packaging film 200.

At this time, in the kitchen towel roll package 100, the percentage of the actual circumference of the packaging film 200 to the theoretical circumference of the packaging film 200 calculated from the wound diameter DR of the above-described kitchen towel roll 1 ((actual film circumference/theoretical film circumference)×100(%)) is preferably 94% or more, more preferably 96% or more, and even more preferably 98% or more for the lower limit. The upper limit is preferably 100% or less, more preferably 99.7% or less, and even more preferably 99.5% or less.

If the percentage is less than 94%, the size of the packaging film 200 becomes small, and the kitchen towel roll 1 is compressed by the packaging film 200, making the kitchen towel roll 1 more likely to be crushed. If the percentage exceeds 100%, the stability (shape retention) of the kitchen towel roll package 100 deteriorates, and the damage to the kitchen towel roll 1 increases.

The kitchen towel roll package may also be a single-roll package or a two-roll package (not illustrated). In that case, the lower limit of the percentage of the actual circumference of the packaging film 200 to the theoretical circumference of the packaging film 200 for a single-roll package ((actual film circumference/theoretical film circumference)×100(%)) is preferably 96% or more, more preferably 98% or more, and even more preferably 99% or more. The upper limit is preferably 108% or less, more preferably 105% or less, and even more preferably 103% or less.

In addition, the lower limit of the percentage of the actual circumference of the packaging film 200 to the theoretical circumference of the packaging film 200 for a two-roll package ((actual film circumference/theoretical film circumference)×100(%)) is preferably 95% or more, more preferably 97% or more, and even more preferably 98% or more. The upper limit is preferably 105% or less, more preferably 103% or less, and even more preferably 101% or less.

The lower limit of the theoretical circumference of the packaging film 200 is preferably 900 mm or more, more preferably 950 mm or more, and even more preferably 1000 mm or more. The upper limit is preferably 1250 mm or less, more preferably 1200 mm or less, and even more preferably 1190 mm or less. The actual film circumference is preferably 880 mm or more, more preferably 940 mm or more, and even more preferably 990 mm or more for the lower limit. The upper limit is preferably 1230 mm or less, more preferably 1230 mm or less, and even more preferably 1140 mm or less.

If the theoretical circumference is less than 900 mm or the actual film circumference is less than 880 mm, the wound diameter DR becomes small, and in order to achieve a certain roll density, the basis weight becomes low, resulting in poor water absorbency of the kitchen towel sheet 1x. If the theoretical circumference exceeds 1250 mm or the actual film circumference exceeds 1230 mm, the wound diameter DR becomes large, and the contact area between rolls increases, resulting in greater damage to the kitchen towel roll 1.

In addition, when the kitchen towel roll package is a single-roll package or a two-roll package, the lower limit of the theoretical circumference for a single-roll package is preferably 390 mm or more, more preferably 420 mm or more, and even more preferably 440 mm or more. The upper limit is preferably 550 mm or less, more preferably 520 mm or less, and even more preferably 500 mm or less. The lower limit of the actual film circumference is preferably 370 mm or more, more preferably 410 mm or more, and even more preferably 430 mm or more. The upper limit is preferably 530 mm or less, more preferably 510 mm or less, and even more preferably 490 mm or less.

For a two-roll package, the lower limit of the theoretical circumference is preferably 740 mm or more, more preferably 760 mm or more, and even more preferably 770 mm or more. The upper limit is preferably 850 mm or less, more preferably 830 mm or less, and even more preferably 810 mm or less. The lower limit of the actual film circumference is preferably 720 mm or more, more preferably 750 mm or more, and even more preferably 760 mm or more. The upper limit is preferably 830 mm or less, more preferably 820 mm or less, and even more preferably 800 mm or less.

The method for determining the theoretical circumference of the packaging film 200 of the kitchen towel roll package 100 is as follows: first, the packaging film 200 of the kitchen towel roll package 100 is torn open, all the kitchen towel rolls 1 are taken out, and the wound diameter DR of each is measured (for three rolls, the center part in the roll width direction is measured for each roll, and the average value of the three rolls is obtained; for two rolls, the average value of the two rolls is obtained; for one roll, two locations are measured per roll, and the average value of the two locations (measurement positions are 30 mm from the upper and lower cut surfaces of the roll) is obtained).

Then, the theoretical circumference of the packaging film 200 is determined based on the following formulas:

Theoretical circumference of packaging film 200 for three rolls=wound diameter×4+wound diameter×3.14
Theoretical circumference of packaging film 200 for two rolls=wound diameter×2+wound diameter×3.14

Theoretical circumference of packaging film 200 for one roll=wound diameter×3.14

The actual circumference of the packaging film 200 is determined by measuring, with a ruler, the circumference direction R near the central part in the height direction of the kitchen towel roll package 100. In the case of a caramel wrap as illustrated in FIG. 9, a part of the packaging film 200 overlaps in the circumference direction R, but the overlapping portion is not included in the circumference.

As described above, according to the present embodiment, it is possible to provide a kitchen towel roll that keeps the basis weight within a certain range without excessively increasing it, and achieves a soft tactile feel and firmness while preserving strength and water absorption amount.

### Examples

Hereinafter, the present disclosure will be described in more detail by way of embodiments, but the present disclosure is not limited in any way by the following embodiments.

Kitchen towel rolls of Examples 1 to 18 and Comparative Examples 1 to 6 illustrated in Tables 1 and 2 were manufactured through the steps of (1) papermaking and creping, (2) embossing and bonding, and (3) roll winding. For all the kitchen towel roll packages of the Examples and Comparative Examples, the above-described parameters were measured, and the following evaluations were performed. Parameters other than the evaluations below were measured according to the above-described standards or measurement methods.

### 1. Basis Weight (Cost)

The basis weight of one ply of the kitchen towel sheet after manufacture was actually measured and evaluated in four grades. The evaluation criteria are as follows:
⊚: 23 g/m² or less
∘: More than 23 g/m² and 25 g/m² or less
Δ: More than 25 g/m² and 27 g/m² or less
x: More than 27 g/m²

### 2. Firmness (Stiffness and Rigidity of Sheet)

The firmness of the kitchen towel sheets when held by hand after manufacture was sensorially evaluated by 20 monitors and rated in five grades according to the number of people who felt “the sheets lack stiffness and rigidity.” The evaluation criteria are as follows:
⊚: 0-3 people felt “the sheets lack stiffness and rigidity”
∘: 4-7 people felt “the sheets lack stiffness and rigidity”
Δ: 8-10 people felt “the sheets lack stiffness and rigidity”
x: 11-15 people felt “the sheets lack stiffness and rigidity”
xx: 16 or more people felt “the sheets lack stiffness and rigidity”

### 3. Softness

The softness of the kitchen towel sheets when held by hand after manufacture was sensorially evaluated by 20 monitors and rated in five grades according to the number of people who felt “the sheets are hard.” The evaluation criteria are as follows:
⊚: 0-3 people felt “the sheets are hard”
∘: 4-7 people felt “the sheets are hard”
Δ: 8-10 people felt “the sheets are hard”
x: 11-15 people felt “the sheets are hard”
XX: 16 or more people felt “the sheets are hard”

### 4. Water Absorption Amount

The water absorption amount per unit area of two plies of the kitchen towel sheet after manufacture was actually measured and evaluated in four grades. The evaluation criteria are as follows:
⊚: 420 g/m² or more
∘: 400 g/m² or more and less than 420 g/m²
Δ: 330 g/m² or more and less than 400 g/m²
x: Less than 330 g/m²

### 5. Tear Resistance

The tear resistance of the kitchen towel sheets when wiping off dirt after manufacture was sensorially evaluated by 20 monitors and rated in five grades according to the number of people who felt that “the sheets are easy to tear.” The evaluation criteria are as follows:
⊚: 0-3 people felt “the sheets are easy to tear”
∘: 4-7 people felt “the sheets are easy to tear”
Δ: 8-10 people felt “the sheets are easy to tear”
x: 11-15 people felt “the sheets are easy to tear”
xx: 16 or more people felt “the sheets are easy to tear”

The conditions and evaluation results of each Example are presented in Tables 1 and 2.

TABLE 1

| | | | | Ex- | Ex- | Ex- | Ex- | Ex- | Ex- | Ex- | Ex- | Comp. | Comp. | Ex- |
|---|---|---|---|---|---|---|---|---|---|---|---|---|---|---|
| Cate- | | | Comp. | ample | ample | ample | ample | ample | ample | ample | ample | Ex. | Ex. | ample |
| gory | Item | Unit | Ex. 1 | 1 | 2 | 3 | 4 | 5 | 6 | 7 | 8 | 2 | 3 | 9 |
| Kitchen | Basis | g/m² | 14.2 | 16.1 | 16.5 | 18.3 | 20.4 | 21.0 | 22.9 | 24.9 | 26.8 | 30.2 | 20.7 | 21.0 |
| Towel | Weight | (1 ply) | | | | | | | | | | | | |
| Sheet | Paper | mm | 1.90 | 2.11 | 2.24 | 2.62 | 2.71 | 2.99 | 3.27 | 3.61 | 4.03 | 4.99 | 3.64 | 3.41 |
| | Thickness | (10 plies) | | | | | | | | | | | | |
| | Specific | cm³/g | 13.4 | 13.1 | 13.6 | 14.3 | 13.3 | 14.2 | 14.3 | 14.5 | 15.0 | 16.5 | 17.6 | 16.2 |
| | Volume | | | | | | | | | | | | | |
| | DMDT | gf/25 mm | 742 | 804 | 816 | 864 | 813 | 1010 | 1180 | 1200 | 1248 | 1373 | 532 | 615 |
| | | (2 plies) | | | | | | | | | | | | |
| | DCDT | gf/25 mm | 726 | 800 | 823 | 857 | 1105 | 1004 | 901 | 1196 | 1306 | 1387 | 501 | 607 |
| | | (2 plies) | | | | | | | | | | | | |
| | DMDT/ | — | 1.0 | 1.0 | 1.0 | 1.0 | 0.7 | 1.0 | 1.3 | 1.0 | 1.0 | 1.0 | 1.1 | 1.0 |
| | DCDT | | | | | | | | | | | | | |
| | GMT | gf/25 mm | 734 | 802 | 819 | 860 | 948 | 1007 | 1031 | 1198 | 1277 | 1380 | 516 | 611 |
| | | (2 plies) | | | | | | | | | | | | |
| | WMDT | gf/25 mm | 264 | 270 | 289 | 308 | 276 | 352 | 433 | 426 | 442 | 501 | 172 | 206 |
| | | (2 plies) | | | | | | | | | | | | |
| | WCDT | gf/25 mm | 250 | 269 | 294 | 298 | 371 | 349 | 330 | 430 | 462 | 486 | 157 | 192 |
| | | (2 plies) | | | | | | | | | | | | |
| | WMDT/ | — | 1.1 | 1.0 | 1.0 | 1.0 | 0.7 | 1.0 | 1.3 | 1.0 | 1.0 | 1.0 | 1.1 | 1.1 |
| | WCDT | | | | | | | | | | | | | |
| | Bending | mN | 9.5 | 9.8 | 10.5 | 11.2 | 11.7 | 13.3 | 14.3 | 15.1 | 16.2 | 17.5 | 4.1 | 4.9 |
| | Resistance | (2 plies) | | | | | | | | | | | | |
| | (MD) | | | | | | | | | | | | | |
| | Bending | mN | 8.3 | 9.2 | 11.0 | 11.1 | 12.8 | 13.0 | 13.8 | 15.5 | 16.9 | 17.4 | 3.6 | 4.5 |
| | Resistance | (2 plies) | | | | | | | | | | | | |
| | (CD) | | | | | | | | | | | | | |
| | Water | g/m² | 309 | 364 | 413 | 417 | 434 | 442 | 458 | 499 | 567 | 632 | 460 | 456 |
| | Absorption | (2 plies) | | | | | | | | | | | | |
| | Amount (per | | | | | | | | | | | | | |
| | Unit Area) | | | | | | | | | | | | | |
| | Water | g/g | 11 | 11 | 13 | 11 | 11 | 11 | 10 | 10 | 11 | 10 | 11 | 11 |
| | Absorption | | | | | | | | | | | | | |
| | Amount (per | | | | | | | | | | | | | |
| | Unit Weight) | | | | | | | | | | | | | |
| | Ratio of | % | 12 | 12 | 12 | 12 | 12 | 12 | 12 | 13 | 13 | 13 | 12 | 13 |
| | Area | | | | | | | | | | | | | |
| | of Linear | | | | | | | | | | | | | |
| | Emboss | | | | | | | | | | | | | |
| | Pattern to | | | | | | | | | | | | | |
| | Sheet Area | | | | | | | | | | | | | |
| | Emboss | mm | 0.14 | 0.17 | 0.18 | 0.22 | 0.25 | 0.25 | 0.25 | 0.28 | 0.31 | 0.35 | 0.35 | 0.31 |
| | Depth | | | | | | | | | | | | | |
| | (Front Side) | | | | | | | | | | | | | |
| | Surface | μm | 76 | 79 | 83 | 81 | 80 | 85 | 86 | 88 | 85 | 89 | 90 | 96 |
| | Roughness | | | | | | | | | | | | | |
| | (Root Mean | | | | | | | | | | | | | |
| | Square | | | | | | | | | | | | | |
| | Height) | | | | | | | | | | | | | |
| | Peel Strength | N/ | 0.21 | 0.24 | 0.25 | 0.20 | 0.30 | 0.31 | 0.29 | 0.32 | 0.28 | 0.26 | 0.31 | 0.32 |
| | | 100 mm | | | | | | | | | | | | |
| Kitchen | Softness of | mm | 3.8 | 3.3 | 2.9 | 2.6 | 2.2 | 2.0 | 1.8 | 1.6 | 1.5 | 1.2 | 1.7 | 1.8 |
| Towel | Wound Roll | | | | | | | | | | | | | |
| Roll | Winding | m/cm² | 0.32 | 0.34 | 0.35 | 0.34 | 0.34 | 0.34 | 0.35 | 0.33 | 0.33 | 0.34 | 0.34 | 0.36 |
| | Density | | | | | | | | | | | | | |
| | Roll Density | g/cm³ | 0.05 | 0.05 | 0.06 | 0.06 | 0.07 | 0.07 | 0.08 | 0.08 | 0.09 | 0.10 | 0.08 | 0.08 |
| | Wound | mm | 155 | 152 | 150 | 152 | 152 | 153 | 152 | 155 | 156 | 153 | 155 | 160 |
| | Diameter | | | | | | | | | | | | | |
| | Wound | m | 28.0 | 28.3 | 28.2 | 28.6 | 28.5 | 29.0 | 29.1 | 28.6 | 28.8 | 28.7 | 29.1 | 33.0 |
| | Length | | | | | | | | | | | | | |
| | Roll Width | mm | 280 | 283 | 285 | 281 | 280 | 282 | 284 | 280 | 28 | 281 | 250 | 248 |
| | (Sheet Width) | | | | | | | | | | | | | |
| | Roll Weight | g | 223 | 258 | 265 | 294 | 326 | 343 | 379 | 399 | 434 | 487 | 301 | 344 |
| | (excluding | | | | | | | | | | | | | |
| | paper | | | | | | | | | | | | | |
| | tube (core)) | | | | | | | | | | | | | |
| | Roll Weight | g | 223 | 255 | 261 | 293 | 326 | 341 | 373 | 399 | 432 | 485 | 337 | 388 |
| | (excluding | | | | | | | | | | | | | |
| | paper tube | | | | | | | | | | | | | |
| | (core), per | | | | | | | | | | | | | |
| | 280 mm | | | | | | | | | | | | | |
| | roll width) | | | | | | | | | | | | | |
| | Core Outer | mm | 44 | 45 | 44 | 44 | 44 | 44 | 46 | 44 | 43 | 44 | 44 | 44 |
| | Diameter | | | | | | | | | | | | | |
| | Apparent | g/m² | 398 | 393 | 404 | 402 | 401 | 400 | 400 | 393 | 409 | 397 | 405 | 417 |
| | Basis | | | | | | | | | | | | | |
| | Weight of | | | | | | | | | | | | | |
| | Core | | | | | | | | | | | | | |
| | Weight of | g | 15.4 | 15.7 | 15.9 | 15.6 | 15.5 | 15.6 | 16.4 | 15.2 | 15.5 | 15.4 | 14.0 | 14.3 |
| | Paper | | | | | | | | | | | | | |
| | Tube per 280 | | | | | | | | | | | | | |
| | mm Roll | | | | | | | | | | | | | |
| | Width | | | | | | | | | | | | | |
| | LBKP | % | 100 | 100 | 100 | 100 | 100 | 100 | 90 | 100 | 100 | 100 | 100 | 50 |
| | Content | | | | | | | | | | | | | |
| | in Core | | | | | | | | | | | | | |
| | NBKP | % | 0 | 0 | 0 | 0 | 0 | 0 | 10 | 0 | 0 | 0 | 0 | 50 |
| | Content | | | | | | | | | | | | | |
| | in Core | | | | | | | | | | | | | |
| Eval- | Basis Weight | g/m² | ⊚ | ⊚ | ⊚ | ⊚ | ⊚ | ⊚ | ⊚ | ◯ | Δ | X | ⊚ | ⊚ |
| uation | (Cost) | (1 ply) | | | | | | | | | | | | |
| | Firmness | — | ◯ | ◯ | ⊚ | ⊚ | ⊚ | ⊚ | ⊚ | ⊚ | ⊚ | ⊚ | X | Δ |
| | (Stiffness | | | | | | | | | | | | | |
| | and Ridigity | | | | | | | | | | | | | |
| | of Sheet) | | | | | | | | | | | | | |
| | Softness | — | ⊚ | ⊚ | ⊚ | ⊚ | ⊚ | ⊚ | ⊚ | ⊚ | ◯ | Δ | ⊚ | ⊚ |
| | Water | g/m² | X | Δ | ◯ | ◯ | ⊚ | ⊚ | ⊚ | ⊚ | ⊚ | ⊚ | ⊚ | ⊚ |
| | Absorption | (2 plies) | | | | | | | | | | | | |
| | Amount | | | | | | | | | | | | | |
| | Tear | — | ◯ | ⊚ | ⊚ | ⊚ | ⊚ | ⊚ | ⊚ | ⊚ | ⊚ | ⊚ | X | Δ |
| | Resistance | | | | | | | | | | | | | |

TABLE 2

| | | | Ex- | Ex- | Ex- | Comp. | Comp. | Ex- | Ex- | Ex- | Ex- | Ex- | Ex- | |
|---|---|---|---|---|---|---|---|---|---|---|---|---|---|---|
| Cate- | | | ample | ample | ample | Ex. | Ex. | ample | ample | ample | ample | ample | ample | Comp. |
| gory | Item | Unit | 10 | 11 | 12 | 4 | 5 | 13 | 14 | 15 | 16 | 17 | 18 | Ex. 6 |
| Kitchen | Basis | g/m² | 21.3 | 21.8 | 22.2 | 22.5 | 21.3 | 21.1 | 21.6 | 21.4 | 21.2 | 21.1 | 21.3 | 22.2 |
| Towel | Weight | (1 ply) | | | | | | | | | | | | |
| Sheet | Paper | mm | 3.25 | 2.71 | 2.52 | 2.58 | 3.87 | 3.80 | 3.42 | 3.23 | 2.90 | 2.83 | 2.67 | 2.41 |
| | Thickness | (10 plies) | | | | | | | | | | | | |
| | Specific | cm³/g | 15.3 | 12.4 | 11.4 | 11.5 | 18.2 | 18.0 | 15.8 | 15.1 | 13.7 | 13.4 | 12.5 | 10.9 |
| | Volume | | | | | | | | | | | | | |
| | DMDT | gf/25 mm | 721 | 1338 | 1444 | 1746 | 486 | 858 | 936 | 979 | 1047 | 1052 | 1185 | 1815 |
| | | (2 plies) | | | | | | | | | | | | |
| | DCDT | gf/25 mm | 733 | 1329 | 1497 | 1890 | 500 | 862 | 944 | 983 | 1002 | 1080 | 1141 | 1920 |
| | | (2 plies) | | | | | | | | | | | | |
| | DMDT/ | — | 1.0 | 1.0 | 1.0 | 0.9 | 1.0 | 1.0 | 1.0 | 1.0 | 1.0 | 1.0 | 1.0 | 0.9 |
| | DCDT | | | | | | | | | | | | | |
| | GMT | gf/25 mm | 727 | 1333 | 1470 | 1817 | 493 | 860 | 940 | 981 | 1024 | 1066 | 1163 | 1867 |
| | | (2 plies) | | | | | | | | | | | | |
| | WMDT | gf/25 mm | 251 | 472 | 521 | 603 | 154 | 311 | 328 | 353 | 368 | 371 | 426 | 666 |
| | | (2 plies) | | | | | | | | | | | | |
| | WCDT | gf/25 mm | 263 | 458 | 536 | 712 | 162 | 326 | 335 | 340 | 342 | 393 | 409 | 733 |
| | | (2 plies) | | | | | | | | | | | | |
| | WMDT/ | — | 1.0 | 1.0 | 1.0 | 0.8 | 1.0 | 1.0 | 1.0 | 1.0 | 1.1 | 0.9 | 1.0 | 0.9 |
| | WCDT | | | | | | | | | | | | | |
| | Bending | mN | 7.6 | 17.5 | 20.9 | 24.2 | 3.5 | 10.9 | 12.1 | 12.4 | 13.5 | 13.7 | 15.5 | 26.2 |
| | Resistance | (2 plies) | | | | | | | | | | | | |
| | (MD) | | | | | | | | | | | | | |
| | Bending | mN | 8.3 | 16.2 | 21.7 | 25.6 | 3.5 | 10.5 | 12.3 | 12.5 | 13.3 | 13.9 | 14.4 | 30.1 |
| | Resistance | (2 plies) | | | | | | | | | | | | |
| | (CD) | | | | | | | | | | | | | |
| | Water | g/m² | 453 | 442 | 424 | 419 | 459 | 470 | 450 | 445 | 435 | 432 | 421 | 409 |
| | Absorption | (2 plies) | | | | | | | | | | | | |
| | Amount (per | | | | | | | | | | | | | |
| | Unit Area) | | | | | | | | | | | | | |
| | Water | g/g | 11 | 10 | 10 | 9 | 11 | 11 | 10 | 10 | 10 | 10 | 10 | 9 |
| | Absorption | | | | | | | | | | | | | |
| | Amount (per | | | | | | | | | | | | | |
| | Unit Weight) | | | | | | | | | | | | | |
| | Ratio of | % | 12 | 12 | 13 | 14 | 3 | 4 | 6 | 9 | 16 | 35 | 50 | 56 |
| | Area of | | | | | | | | | | | | | |
| | Linear | | | | | | | | | | | | | |
| | Emboss | | | | | | | | | | | | | |
| | Pattern to | | | | | | | | | | | | | |
| | Sheet Area | | | | | | | | | | | | | |
| | Emboss | mm | 0.28 | 0.22 | 0.18 | 0.14 | 1.17 | 1.05 | 0.55 | 0.35 | 0.14 | 0.10 | 0.06 | 0.04 |
| | Depth | | | | | | | | | | | | | |
| | (Front Side) | | | | | | | | | | | | | |
| | Surface | μm | 92 | 95 | 90 | 91 | 78 | 80 | 85 | 81 | 83 | 77 | 79 | 80 |
| | Roughness | | | | | | | | | | | | | |
| | (Root Mean | | | | | | | | | | | | | |
| | Square | | | | | | | | | | | | | |
| | Height) | | | | | | | | | | | | | |
| | Peel Strength | N/ | 0.27 | 0.30 | 0.29 | 0.33 | 0.29 | 0.32 | 0.35 | 0.33 | 0.37 | 0.34 | 0.39 | 0.35 |
| | | 100 mm | | | | | | | | | | | | |
| Kitchen | Softness of | mm | 1.9 | 2.4 | 2.5 | 2.6 | 1.6 | 1.6 | 1.8 | 1.9 | 2.1 | 2.2 | 2.3 | 2.8 |
| Towel | Wound Roll | | | | | | | | | | | | | |
| Roll | Winding | m/cm² | 0.35 | 0.32 | 0.33 | 0.32 | 0.36 | 0.37 | 0.38 | 0.38 | 0.34 | 0.36 | 0.31 | 0.35 |
| | Density | | | | | | | | | | | | | |
| | Roll Density | g/cm³ | 0.08 | 0.08 | 0.08 | 0.08 | 0.07 | 0.08 | 0.08 | 0.08 | 0.07 | 0.07 | 0.06 | 0.07 |
| | Wound | mm | 157 | 158 | 161 | 159 | 148 | 146 | 145 | 144 | 147 | 145 | 149 | 150 |
| | Diameter | | | | | | | | | | | | | |
| | Wound | m | 31.5 | 28.5 | 30.7 | 28.9 | 27.5 | 27.8 | 27.4 | 27.9 | 26.0 | 27.7 | 25.2 | 28.3 |
| | Length | | | | | | | | | | | | | |
| | Roll Width | mm | 250 | 249 | 245 | 246 | 290 | 288 | 295 | 294 | 299 | 300 | 296 | 295 |
| | (Sheet | | | | | | | | | | | | | |
| | Width) | | | | | | | | | | | | | |
| | Roll Weight | g | 335 | 309 | 334 | 320 | 340 | 338 | 349 | 351 | 330 | 351 | 318 | 371 |
| | (excluding | | | | | | | | | | | | | |
| | paper | | | | | | | | | | | | | |
| | tube (core)) | | | | | | | | | | | | | |
| | Roll Weight | g | 376 | 348 | 382 | 364 | 328 | 328 | 331 | 334 | 309 | 327 | 301 | 352 |
| | (excluding | | | | | | | | | | | | | |
| | paper | | | | | | | | | | | | | |
| | tube (core), | | | | | | | | | | | | | |
| | per 280 mm | | | | | | | | | | | | | |
| | roll width) | | | | | | | | | | | | | |
| | Core Outer | mm | 44 | 44 | 44 | 44 | 50 | 49 | 50 | 45 | 43 | 40 | 40 | 41 |
| | Diameter | | | | | | | | | | | | | |
| | Apparent | g/m² | 397 | 401 | 411 | 412 | 395 | 406 | 350 | 409 | 409 | 449 | 352 | 395 |
| | Basis | | | | | | | | | | | | | |
| | Weight | | | | | | | | | | | | | |
| | of Core | | | | | | | | | | | | | |
| | Weight | g | 13.7 | 13.8 | 13.9 | 14.0 | 18.0 | 18.0 | 16.2 | 17.0 | 16.5 | 16.9 | 13.1 | 15.0 |
| | of Paper | | | | | | | | | | | | | |
| | Tube per | | | | | | | | | | | | | |
| | 280 mm | | | | | | | | | | | | | |
| | Roll Width | | | | | | | | | | | | | |
| | LBKP | % | 70 | 100 | 100 | 100 | 100 | 90 | 92 | 100 | 100 | 98 | 99 | 100 |
| | Content | | | | | | | | | | | | | |
| | in Core | | | | | | | | | | | | | |
| | NBKP | % | 30 | 0 | 0 | 0 | 0 | 10 | 8 | 0 | 0 | 2 | 1 | 0 |
| | Content | | | | | | | | | | | | | |
| | in Core | | | | | | | | | | | | | |
| Eval- | Basis Weight | g/m² | ⊚ | ⊚ | ⊚ | ⊚ | ⊚ | ⊚ | ⊚ | ⊚ | ⊚ | ⊚ | ⊚ | ⊚ |
| uation | (Cost) | (1 ply) | | | | | | | | | | | | |
| | Firmness | — | ◯ | ⊚ | ⊚ | ⊚ | XX | Δ | ◯ | ⊚ | ⊚ | ⊚ | ⊚ | ⊚ |
| | (Stiffness and | | | | | | | | | | | | | |
| | Ridigity | | | | | | | | | | | | | |
| | of Sheet) | | | | | | | | | | | | | |
| | Softness | — | ⊚ | ◯ | Δ | X | ⊚ | ⊚ | ⊚ | ⊚ | ⊚ | ◯ | Δ | XX |
| | Water | g/m² | ⊚ | ⊚ | ⊚ | ◯ | ⊚ | ⊚ | ⊚ | ⊚ | ⊚ | ⊚ | ⊚ | ◯ |
| | Absorption | | | | | | | | | | | | | |
| | Amount | (2 plies) | | | | | | | | | | | | |
| | Tear | — | ◯ | ⊚ | ⊚ | ⊚ | XX | ⊚ | ⊚ | ⊚ | ⊚ | ⊚ | ⊚ | ⊚ |
| | Resistance | | | | | | | | | | | | | |

From the above, it was confirmed that, according to the present embodiment, a kitchen towel roll can be obtained that keeps the basis weight within a certain range without excessively increasing it, and achieves a soft tactile feel and firmness while preserving strength and water absorption amount.

### REFERENCE SIGNS LIST

1 Kitchen towel roll
1a Surface
1b Back surface
1 e Outer peripheral edge of kitchen towel roll
1x Kitchen towel sheet
10 Test piece
10a, 10d Corner portion
11 Belt
12 Holder
20 Belt press portion
21 Dewatering roll
22 Yankee dryer
23 Textured belt
24 Wet paper
100 Kitchen towel roll package
200 Packaging film

1. A kitchen towel roll obtained by bonding, with glue or water, sheets having an emboss pattern imparted to one or both of two plies, laminating the sheets to form a two-ply kitchen towel sheet, and winding the kitchen towel sheet into a roll, wherein:
a basis weight of one ply of the kitchen towel sheets is 16 g/m² or more and 27 g/m² or less;
a dry machine direction tensile strength DMDT and a dry cross direction tensile strength DCDT of the kitchen towel sheet according to JIS P 8113 are each 600 gf/25 mm or more and 1500 gf/25 mm or less, and a ratio of the DMDT to the DCDT (DMDT/DCDT) is 0.3 or more and 2.5 or less;
a bending resistance of the kitchen towel sheet in the MD direction and in the CD direction is each 4.5 mN or more and 22.0 mN or less; and
a water absorption amount per unit area of the kitchen towel sheet is 330 g/m² or more and 600 g/m² or less.

2. The kitchen towel roll according to claim 1, wherein a specific volume of the kitchen towel sheet is 7.6 cm³/g or more and 19.2 cm³/g or less.

3. The kitchen towel roll according to claim 1, wherein the emboss pattern is linear, and
an area occupied by s having a width of 0.1 mm or more and 4 mm or less and a length of 5 mm or more in the linear emboss pattern accounts for 4% or more and 50% or less of an area of the kitchen towel sheet.

4. The kitchen towel roll according to claim 1, wherein an emboss depthemboss depthemboss depth in the emboss pattern is 0.06 mm or more and 1.05 mm or less.

5. The kitchen towel roll according to claim 1, wherein the kitchen towel sheet has an uneven pattern originating from a papermaking process that is different from the emboss pattern.

6. The kitchen towel roll according to claim 1, wherein a paper thickness of the kitchen towel sheet is 1.3 mm/10 plies or more and 5.0 mm/10 plies or less.

7. The kitchen towel roll according to claim 1, wherein a wound diameter of the roll is 110 mm or more and 189 mm or less.

8. The kitchen towel roll according to claim 1, wherein an MD-direction elongation of the kitchen towel sheet according to JIS P 8113 is 6% or more and 15% or less.

9. The kitchen towel roll according to claim 1, wherein a CD-direction elongation of the kitchen towel sheet according to JIS P 8113 is 3% or more and 10% or less.

10. The kitchen towel roll according to claim 1, wherein a softness of the wound roll is 1.2 mm or more and 4.0 mm or less.

11. The kitchen towel roll according to claim 1, wherein a peel strength of the kitchen towel sheet is 0.03 N/100 mm or more and 0.5 N/100 mm or less.

12. The kitchen towel roll according to claim 1, wherein a root mean square height of surface roughness, in a portion of the kitchen towel sheet where the emboss pattern is not imparted, is 35 μm or more and 170 μm or less.

13. The kitchen towel roll according to claim 1, wherein the kitchen towel sheet is wound on a paper core, and a weight content of LBKP (Bleached hardwood kraft pulp) in base paper used for the paper core is 50% or more and 100% or less.
